(19) United States
(12) Patent Application Publication
(10) Pub. No.: US 2014/0042742 A1
(43) Pub. Date: Feb. 13, 2014

(54) COMBINATION OF THIN-WALLED PIPE AND JOINT, AND METHOD FOR FORMING THE SAME

(71) Applicants: Haohui Pang, Foshan (CN); Zhaohui Shi, Zhuhai (CN)

(72) Inventor: Haohui PANG, Foshan (CN)

(73) Assignees: Zhaohui Shi, Zhuhai (CN); Haohui Pang, Foshan (CN)

(21) Appl. No.: 14/060,609

(22) Filed: Oct. 22, 2013

Related U.S. Application Data
(63) Continuation-in-part of application No. PCT/CN2012/000558, filed on Apr. 25, 2012.
Application No. PCT/CN2012/000558 is a continuation-in-part of application No. PCT/CN2012/000687, filed on May 18, 2012.

(30) Foreign Application Priority Data
Apr. 22, 2011 (CN) 201110101039.9
Apr. 25, 2011 (CN) 201110105752.0

(51) Int. Cl. F16L 19/02

(52) U.S. Cl. CPC F16L 19/0218
USPC 285/355; 29/525.11

(57) ABSTRACT

A combination of a thin-walled metal pipe and a joint, including the thin-walled metal pipe, the joint, a sealing ring, and a socket ring. One end of the metal pipe is pressed by a pair of pliers to form a boss. One end of the joint is provided with an opening including a female thread for receiving the metal pipe. A step is disposed at the bottom of the opening. The socket ring comprises male thread corresponding to the female thread. The sealing ring and the socket ring are sleeved on the metal pipe and are separated by the boss. When the socket ring is screwed down, the female thread and the male thread cooperate with each other tightly, so that the socket ring leans against the boss and extrudes the sealing ring to press the step at the bottom of the opening to form a sealed combination.

### CROSS-REFERENCE TO RELATED APPLICATIONS

This application is a continuation-in-part of International Patent Application No. PCT/CN2012/000558 with an international filing date of Apr. 25, 2012, and is also a continuation-in-part of International Patent Application No. PCT/CN2012/000687 with an international filing date of May 18, 2012, designating the United States, now pending, and further claims priority benefits to Chinese Patent Application No. 201110101039.9 filed Apr. 22, 2011, and to Chinese Patent Application No. 201110105752.0 filed Apr. 25, 2011, respectively. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a combination of a thin-walled metal pipe and a joint as well as a method for forming the combination.

2. Description of the Related Art

Typically, metal pipes are connected by press fitting orsocket welding, both of which are fixed connections. To connect pipes during assembly or to disconnect them when repair or maintenance is required, special tools are employed, which results in increased space requirements and increases labor intensity, assembly skills, and costs.

Flexible connections achieved by ring expansion connection solve the difficulty of assembly and disassembly of pipes to some extent. However, soldered side seams of thin-walled pipes are prone to cracking in the process of ring expansion. Furthermore, in the case of leakage during pipe layering, ring expansion cannot be used because pipes are usually buried in concrete.

### SUMMARY OF THE INVENTION

In view of the above-described problems, the invention provides in one aspect a combination of a thin-walled metal pipe and a joint as well as a method for forming the combination. The method is simple, time and material-saving, and convenientin operation. The resulting combination is joined by a firm and reliable connection, and has excellent sealing properties. There is also a space provided between the metal pipe and the joint for buffering the thermal expansion of the metal pipe in case of temperature fluctuations.

In accordance with one embodiment of the invention, there is provided a combination of a thin-walled metal pipe and a joint comprising the thin-walled metal pipe, the joint, a sealing ring, and a socket ring. One end of the metal pipe is pressed by a pair of pliers to form a boss. One end of the joint is provided with an opening comprising female thread for receiving the metal pipe. A step is disposed at the bottom of the opening. The socket ring comprises male thread corresponding to the female thread of the opening. The sealing ring and the socket ring are sleeved on the metal pipe and are separated by the boss. When the socket ring is screwed down, the female thread and the male thread cooperate with each other tightly, and the socket ring leans against the boss and extrudes the sealing ring to press the step at the bottom of the opening of the metal pipe to form a sealed combination.

In a class of this embodiment, the boss at one end of the metal pipe is at least two in number, the number is in direct proportion to a diameter of the metal pipe, and the bosses on the metal pipe are distributed equidistantly or not equidistantly.

In a class of this embodiment, a space between the boss and the end of the metal pipe is less than or equal to 60 mm, the space between each boss on the metal pipe and the end is the same, and a height of the boss in relation to an outer surface of the metal pipe is less than or equal to 6 mm.

In a class of this embodiment, when the socket ring is screwed and engaged with the joint under the action of the female thread and the male thread, the boss is surrounded by the joint, a spanner is employed to tighten the socket ring, and a space between the step at the bottom of the joint and an end face of the socket ring is 2 mm larger than a diameter of the boss.

In accordance with another embodiment of the invention, there provided is a method for forming a combination of a thin-walled metal pipe and a joint. The method comprises the following steps:
a) pressing one end of a thin-walled metal pipe by a pair of pliers to form a boss;
b) providing a joint, expanding and rolling one end of the joint to yield an opening comprising female thread, and disposing a step at a bottom of the opening;
c) sleeving a sealing ring and a socket ring comprising male thread on the metal pipe from two opposite directions of the boss;
d) inserting the metal pipe sleeved with the socket ring and the sealing ring into the opening of the joint; and
e) screwing the socket ring along the female thread of the opening into the opening of the joint, and tightening the socket ring by using a spanner, so that the socket ring leans against the boss and extrudes the sealing ring to press the step at the bottom of the opening of the metal pipe to form a sealed combination.

In a class of this embodiment, the joint is made of thin-walled metal materials, and a wall thickness of the joint is larger than or equal to that of the metal pipe.

In a class of this embodiment, the wall thickness of the joint is no more than 2.5 times that of the metal pipe.

Advantages of the invention are as follows. The pliers can work out a boss on the pipe wall quickly and cause no destruction to pipes, and no need of invasive operations such as press fitting, socket welding, and ring expansion. The method is particularly suitable for the connection of thin-walled metal pipes and thin-walled joints. By the interaction of the female thread of the joint and the male thread of the socket ring, the connection is made reliable, stable, and sealed. The method for making the connection is simple, time and material saving, convenient for assembly and disassembly, and requires little space for operation.

### BRIEF DESCRIPTION OF THE DRAWINGS

The invention is described hereinbelow with reference to the accompanying drawings, in which:

FIG. 1 is an exploded view of a combination of a thin-walled metal pipe and a joint of an exemplary embodiment of the invention; and

FIG. 2 is an exploded view of a combination of a thin-walled metal pipe and a joint of another exemplary embodiment of the invention.

### DETAILED DESCRIPTION OF THE EMBODIMENTS

For further illustrating the invention, experiments detailing a combination of a thin-walled metal pipe and a joint and a method for forming the same are described below. It should be noted that the following examples are intended to describe and not to limit the invention.

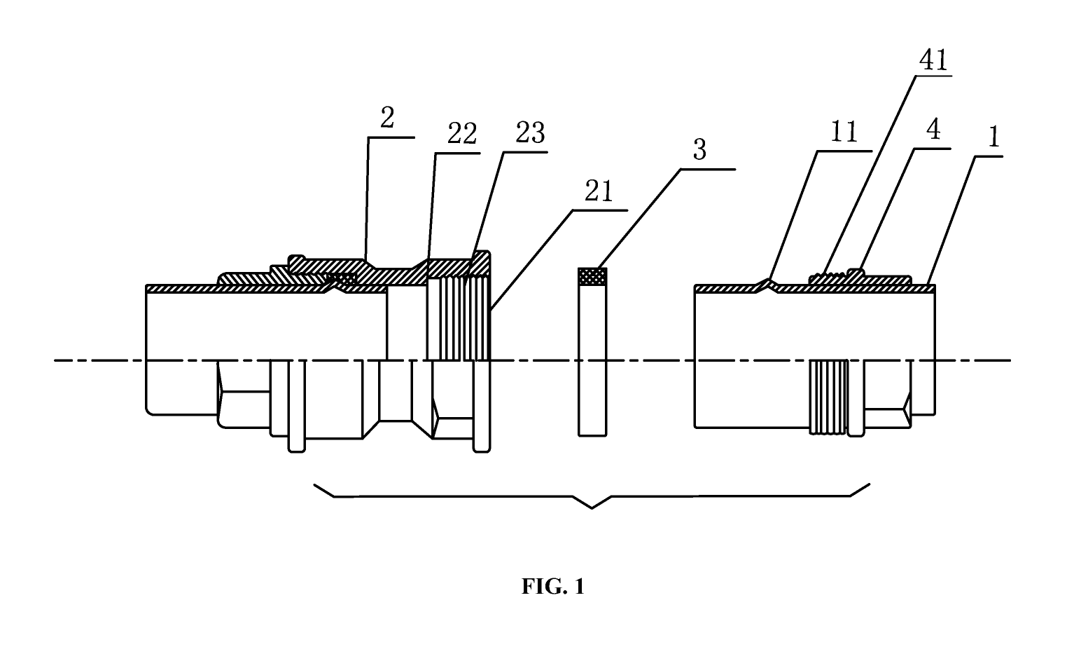

As shown in FIG. 1, a combination of a thin-walled metal pipe and a joint comprises a thin walled stainless steel pipe 1, a joint 2, a rubber sealing ring 3, and a socket ring 4. The socket ring 4 comprises male thread 41. One end of the pipe 1 is pressed by a pair of pliers to yield a boss 11. One end of the joint 2 is provided an opening 21 for receiving the pipe 1. A step 22 is disposed at the bottom of the opening 21. An internal wall of the joint 2 comprises female thread 23 corresponding to the male thread 41 of the socket ring 4.

Upon assembly, the socket ring 4 is sleeved on the pipe 1. One end of the pipe 1 is pressed by a pair of pliers to yield the boss 11. The sealing ring 3 is sleeved on the pipe 1 from a near-end of the boss and thus the socket ring 4 and the sealing ring 3 are separated by the boss 11. The socket ring 4, together with the sealing ring 3 and the boss, is inserted into the opening 21 of the joint 2. The sealing ring 3 tightly leans against the step 22 at the bottom of the joint 2. The male thread 41 of the socket ring 4 is screwed along the female thread of the opening 21 into the opening of the joint. The socket ring 4 is tightened by using a spanner, so that the socket ring 4 leans against the boss 11 and extrudes the sealing ring 3 to press the step 22 at the bottom of the opening 21 of the metal pipe 1 to form a sealed combination. In this way, a space between the step 22 at the bottom of the joint 2 and an end face of the socket ring 4 is at least 2 mm larger than a diameter of the boss 11. Thus, in case of temperature fluctuation, the space between the metal pipe and the joint provides sufficient axial extension, thereby buffering the thermal expansion of the metal pipe.

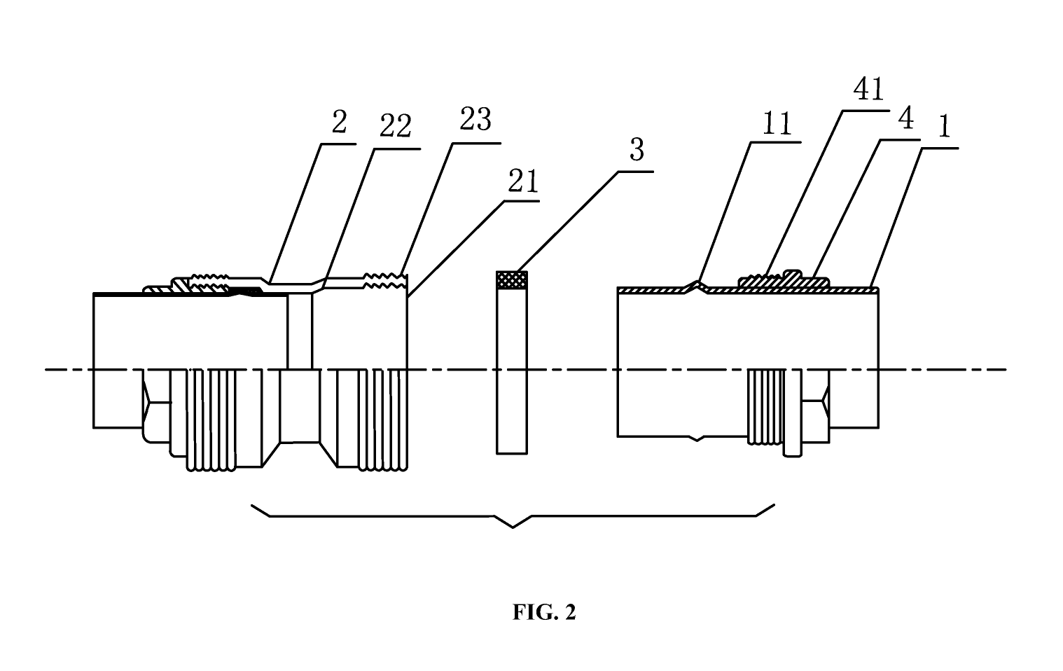

Optionally, the joint is made of thin-walled metal materials, as shown in FIG. 2. A wall thickness of the joint is larger than or equal to that of the metal pipe. Preferably, the wall thickness of the joint is no more than 2.5 times that of the metal pipe.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A sealed combination of a thin-walled metal pipe and a joint, comprising:
a) the thin-walled metal pipe;
b) the joint;
c) a sealing ring; and
d) a socket ring;
wherein
one end of the metal pipe is adapted to be pressed with a pair of pliers to form a boss;
one end of the joint is provided with an opening comprising female thread for receiving the thin-walled metal pipe;
a step is disposed at the bottom of the opening;
the socket ring comprises male thread corresponding to the female thread of the opening;
the sealing ring and the socket ring are sleeved on the metal pipe and are separated by the boss; and
when the socket ring is screwed down, the female thread and the male thread cooperate with each other, so that the socket ring presses against the boss and forces out the sealing ring to press against the step at the bottom of the opening to form the sealed combination.

2. The combination of claim 1, wherein the boss at the end of the thin-walled metal pipe is at least two in number, the number is in direct proportion to a diameter of the thin-walled metal pipe, and the bosses on the thin-walled metal pipe are distributed equidistantly or not equidistantly.

3. The combination of claim 1, wherein a space between the boss and the end of the thin-walled metal pipe is less than or equal to 60 mm, the space between each boss on the thin-walled metal pipe and the end is the same, and a height of the boss in relation to an outer surface of the thin-walled metal pipe is less than or equal to 6 mm

4. The combination of claim 1, wherein when the socket ring is screwed and engaged with the joint under the action of the female thread and the male thread, the boss is surrounded by the joint, a spanner is employed to tighten the socket ring, and a space between the step at the bottom of the joint and an end face of the socket ring is at least 2 mm larger than a diameter of the boss.

5. A method for forming a sealed combination of a thin-walled metal pipe and a joint, the method comprising:
a) pressing one end of a thin-walled metal pipe by a pair of pliers to form a boss;
b) providing a joint, expanding and rolling one end of the joint to yield an opening comprising female thread, and disposing a step at a bottom of the opening;
c) sleeving a sealing ring and a socket ring comprising male thread on the thin-walled metal pipe from two opposite directions of the boss;
d) inserting the metal pipe sleeved with the socket ring and the sealing ring into the opening of the joint; and
e) screwing the socket ring along the female thread of the opening into the opening of the joint, and tightening the socket ring by using a spanner, so that the socket ring leans against the boss and forces out the sealing ring to press the step at the bottom of the opening of the metal pipe to form the sealed combination.

6. The method of claim 5, wherein the joint is made of thin-walled metal materials, and a wall thickness of the joint is larger than or equal to that of the metal pipe.

7. The method of claim 6, wherein the wall thickness of the joint is no more than 2.5 times that of the metal pipe.
